(19) United States
(12) Patent Application Publication
(10) Pub. No.: US 2026/0266598 A1
(43) Pub. Date: Sep. 10, 2026

(54) DEPTH SENSOR DEVICE AND METHOD FOR OPERATING A DEPTH SENSOR DEVICE

(71) Applicant: Sony Semiconductor Solutions Corporation, Kanagawa (JP)

(72) Inventor: Nicolas PIRO, Stuttgart (DE)

(73) Assignee: Sony Semiconductor Solutions Corporation, Kanagawa (JP)

(21) Appl. No.: 19/166,049

(22) PCT Filed: Mar. 7, 2024
(86) PCT No.: PCT/EP2024/055961

§ 371 Date: Sep. 17, 2025

(30) Foreign Application Priority Data
Mar. 27, 2023 (EP) 23164228.1

(51) Int. Cl. G01B 11/25; H04N 25/47; H04N 25/707

(52) U.S. Cl. CPC G01B 11/2513; G01B 11/2518; G01B 11/2531; H04N 25/47; H04N 25/707

(57) ABSTRACT

A sensor device for generating depth information for an object, comprising a projector unit that is configured to project illumination patterns to the object; a receiver unit that is configured to detect intensities of light reflected from the object stemming from the illumination with the illumination patterns and/or from illumination with ambient light; and a control unit. The control unit comprises a system parameter unit that is configured to set system parameters of the sensor device, a decoder unit that is configured to generate the depth information based on the illumination patterns reflected from the object and detected by the receiver unit, and an optimizer unit that is configured to determine system parameter changes that maximize the depth sensing performance in current environmental conditions.

### FIELD OF THE INVENTION

The present disclosure relates to a sensor device and a method for operating a sensor device. In particular, the present disclosure is related to the generation of depth information.

### BACKGROUND

In recent years techniques for automatic measurement of distances by sending and receiving light have drawn considerable attention. Such techniques comprise the usage of structured light, i.e. the illumination of an object with static or time varying sparse light patterns in various solid angles such as to generate e.g. line, bar or checkerboard patterns, or active stereo depth sensing. For a known orientation of light source and camera it is possible to determine the shape and the distance of an object from triangulation based on the known positions of the light source, the camera, the orientation of the emitted light in space, and the position of the according light signal on the camera.

### SUMMARY OF THE INVENTION

In conventional systems for depth estimation a set of illumination patterns providing high intensities at predetermined solid angles is sent out to an object and the distribution of light reflected from the object is measured by a receiver such as a camera (or two receivers for active stereo depth sensing). The task is then to find for the known solid angles of light emission, the solid angles of maximum light reception on the receiver. Due to the limited density of intensity changes in the illumination pattern and the limited pixel resolution, for the determination of the solid angle of maximum light reception a fit of the expected intensity distribution to the measured intensity values is necessary In conventional systems this requires storage of all intensity values obtained at all pixels of the camera for all different illuminations. Only after all intensity values have been stored, a depth map can be generated. Thus, in conventional systems memory space must be large. In addition, complete storage of intensity values leads to an enhanced latency in the system. Also, the available pixel resolution is limited by the readout speed, if applications with real-time behavior are envisaged, since too many pixels will lead to too long processing times.

These shortcomings of conventional depth estimation techniques may be mitigated by using event-based sensors, i.e. sensors that are sensitive only to changes in the received signal. The present disclosure aims to improve depth sensing via structured light that is based on event-based sensors, in the following EVS-based structured light system or EVS-based STL system. The performance of such an EVS-based STL system depends on the current operation environmental conditions, such as scene or distance. The performance of STL systems degrades significantly if it operates in a condition different to the one it was optimized for. Thus, an object is to provide optimized depth sensing in changing environments (e.g. VR/AR).

To this end, a sensor device for generating depth information for an object is provided that comprises a projector unit that is configured to project illumination patterns to the object. The sensor device further comprises a receiver unit that is configured to detect intensities of light reflected from the object stemming from the illumination with the illumination patterns and/or from illumination with ambient light, and a control unit. The control unit comprises a system parameter unit that is configured to set system parameters of the sensor device, a decoder unit that is configured to generate the depth information based on the illumination patterns reflected from the object and detected by the receiver unit, and an optimizer unit that is configured to determine system parameter changes that maximize the depth sensing performance in current environmental conditions.

Further, a method for optimizing the depth sensor performance in real-time, is provided, the method comprising: applying a modulation to a system parameter to be optimized at a specific frequency, detecting I-Q components of the depth information signal of the decoder unit that oscillates at the applied modulation frequency, extracting the Q component and using it as an estimate of the signal derivative with respect to the system parameter to be optimized, and applying a change in the system parameter in dependence to the value of the signal derivative.

By optimizing the system parameters of the structured light system in real time, this invention would allow to keep a constant performance across many conditions, while maintaining the fast performance of an EVS sensor.

### BRIEF DESCRIPTION OF THE DRAWINGS

FIG. 1A is a simplified block diagram of the event detection circuitry of a solid-state imaging device including a pixel array.

FIG. 1B is a simplified block diagram of the pixel array illustrated in FIG. 1A.

FIG. 1C is a simplified block diagram of the imaging signal read-out circuitry of the solid-state imaging device of FIG. 1A.

FIG. 2 shows schematically a sensor device.

FIG. 3 shows schematically another sensor device.

FIG. 4 shows another schematic representation of a sensor device.

FIG. 5 shows an exemplary series of code words that encode illumination patterns.

FIG. 6 shows schematically generation of depth information in a sensor device.

FIG. 7 shows schematically spatially tiled illumination patterns.

FIG. 8 shows schematically a pixel array comprising pixels adapted to different wavelengths.

FIG. 9 shows schematically a sensor device comprising a projector unit, a receiver unit and a control unit.

FIG. 10A shows schematically a projector unit and its projector system parameters.

FIG. 10B shows schematically a receiver unit and its receiver system parameters.

FIG. 11 shows schematically modulation and demodulation of I/Q components.

FIGS. 12A and 12B show schematically different exemplary applications of a camera comprising a depth sensor device.

FIG. 13 shows schematically a head mounted display comprising a depth sensor device.

FIG. 14 shows schematically an industrial production device comprising a depth sensor device.

FIG. 15A shows a schematic process flow of a method of operating a sensor device.

FIG. 15B shows a schematic process flow of a method of operating a sensor device.

FIG. 16 is a simplified perspective view of a solid-state imaging device with laminated structure according to an embodiment of the present disclosure.

FIG. 17 illustrates simplified diagrams of configuration examples of a multi-layer solid-state imaging device to which a technology according to the present disclosure may be applied.

FIG. 18 is a block diagram depicting an example of a schematic configuration of a vehicle control system.

FIG. 19 is a diagram of assistance in explaining an example of installation positions of an outside-vehicle information detecting section and an imaging section of the vehicle control system of FIG. 18.

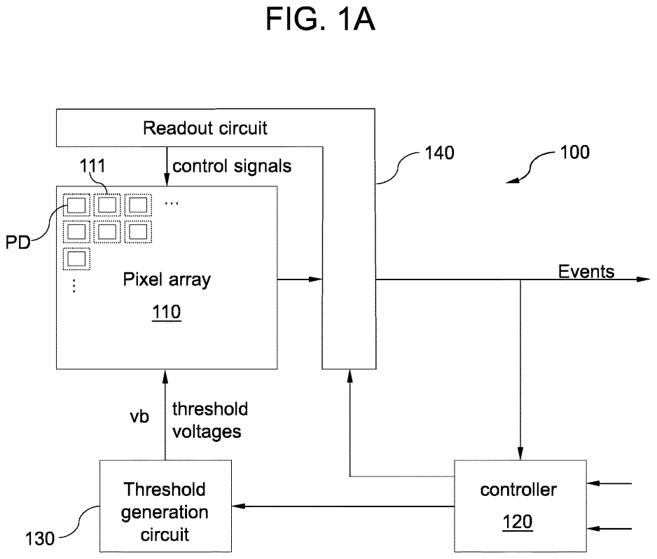

The present disclosure relies on event detection by event vision sensor/dynamic vision sensors. Although these sensors are in principle known to a skilled person a brief overview will be given with respect to FIGS. 1A to 1C. FIG. 1A is a block diagram of a solid-state imaging device 100 employing event-based change detection. The solid-state imaging device 100 includes a pixel array 110 with one or more imaging pixels 111, wherein each pixel 111 includes a photoelectric conversion element PD. The pixel array 110 may be a one-dimensional pixel array with the photoelectric conversion elements PD of all pixels arranged along a straight or meandering line (line sensor). In particular, the pixel array 110 may be a two-dimensional array, wherein the photoelectric conversion elements PDs of the pixels 111 may be arranged along straight or meandering rows and along straight or meandering lines.

The illustrations show a two-dimensional array of pixels 111, wherein the pixels 111 are arranged along straight rows and along straight columns running orthogonal to the rows. Each pixel 111 converts incoming light into an imaging signal representing the incoming light intensity and an event signal indicating a change of the light intensity, e.g. an increase by at least an upper threshold amount (positive polarity) and/or a decrease by at least a lower threshold amount (negative polarity). If necessary, the function of each pixel 111 regarding intensity and event detection may be divided and different pixels observing the same solid angle can implement the respective functions. These different pixels may be subpixels and can be implemented such that they share part of the circuitry. The different pixels may also be part of different image sensors. For the present disclosure, whenever it is referred to a pixel capable of generating an imaging signal and an event signal, this should be understood to include also a combination of pixels separately carrying out these functions as described above.

A controller 120 performs a flow control of the processes in the pixel array 110. For example, the controller 120 may control a threshold generation circuit 130 that determines and supplies thresholds to individual pixels 111 in the pixel array 110. A readout circuit 140 provides control signals for addressing individual pixels 111 and outputs information about the position of such pixels 111 that indicate an event. Since the solid-state imaging device 100 employs event-based change detection, the readout circuit 140 may output a variable amount of data per time unit.

FIG. 1B shows exemplarily details of the imaging pixels 111 in FIG. 1A as far as their event detection capabilities are concerned. Of course, any other implementation that allows detection of events can be employed. Each pixel 111 includes a photoreceptor module PR and is assigned to a pixel back-end 300, wherein each complete pixel back-end 300 may be assigned to one single photoreceptor module PR. Alternatively, a pixel back-end 300 or parts thereof may be assigned to two or more photoreceptor modules PR, wherein the shared portion of the pixel back-end 300 may be sequentially connected to the assigned photoreceptor modules PR in a multiplexed manner.

The photoreceptor module PR includes a photoelectric conversion element PD, e.g. a photodiode or another type of photosensor. The photoelectric conversion element PD converts impinging light 9 into a photocurrent Iphoto through the photoelectric conversion element PD, wherein the amount of the photocurrent Iphoto is a function of the light intensity of the impinging light 9.

A photoreceptor circuit PRC converts the photocurrent Iphoto into a photoreceptor signal Vpr. The voltage of the photoreceptor signal Vpr is a function of the photocurrent Iphoto.

A memory capacitor 310 stores electric charge and holds a memory voltage whose amount depends on a past photoreceptor signal Vpr. In particular, the memory capacitor 310 receives the photoreceptor signal Vpr such that a first electrode of the memory capacitor 310 carries a charge that is responsive to the photoreceptor signal Vpr and thus the light received by the photoelectric conversion element PD. A second electrode of the memory capacitor C1 is connected to the comparator node (inverting input) of a comparator circuit 340. Thus the voltage of the comparator node, Vdiff varies with changes in the photoreceptor signal Vpr.

The comparator circuit 340 compares the difference between the current photoreceptor signal Vpr and the past photoreceptor signal to a threshold. The comparator circuit 340 can be in each pixel back-end 300, or shared between a subset (for example a column) of pixels. According to an example each pixel 111 includes a pixel back-end 300 including a comparator circuit 340, such that the comparator circuit 340 is integral to the imaging pixel 111 and each imaging pixel 111 has a dedicated comparator circuit 340.

A memory element 350 stores the comparator output in response to a sample signal from the controller 120. The memory element 350 may include a sampling circuit (for example a switch and a parasitic or explicit capacitor) and/or a digital memory circuit such as a latch or a flip-flop). In one embodiment, the memory element 350 may be a sampling circuit. The memory element 350 may be configured to store one, two or more binary bits.

An output signal of a reset circuit 380 may set the inverting input of the comparator circuit 340 to a predefined potential. The output signal of the reset circuit 380 may be controlled in response to the content of the memory element 350 and/or in response to a global reset signal received from the controller 120.

The solid-state imaging device 100 is operated as follows: A change in light intensity of incident radiation 9 translates into a change of the photoreceptor signal Vpr. At times designated by the controller 120, the comparator circuit 340 compares Vdiff at the inverting input (comparator node) to a threshold Vb applied on its non-inverting input. At the same time, the controller 120 operates the memory element 350 to store the comparator output signal Vcomp. The memory element 350 may be located in either the pixel circuit 111 or in the readout circuit 140 shown in FIG. 1A. The threshold Vb may be equivalent to an event threshold EvTh, which is a receiver system parameter SP_Rec of a receiver unit 1020, which will be discussed in all detail below.

If the state of the stored comparator output signal indicates a change in light intensity AND the global reset signal GlobalReset (controlled by the controller 120) is active, the conditional reset circuit 380 outputs a reset output signal that resets Vdiff to a known level. The time period between respective outputs of the signal GlobalReset may be equivalent to an exposure time ET, which is a receiver system parameter SP_Rec of the receiver unit 1020, which will be discussed in all detail below.

The memory element 350 may include information indicating a change of the light intensity detected by the pixel 111 by more than a threshold value.

The solid-state imaging device 120 may output the addresses (where the address of a pixel 111 corresponds to its row and column number) of those pixels 111 where a light intensity change has been detected. A detected light intensity change at a given pixel is called an event. More specifically, the term ‘event’ means that the photoreceptor signal representing and being a function of light intensity of a pixel has changed by an amount greater than or equal to a threshold applied by the controller through the threshold generation circuit 130. To transmit an event, the address of the corresponding pixel 111 is transmitted along with data indicating whether the light intensity change was positive or negative. The data indicating whether the light intensity change was positive or negative may include one single bit.

To detect light intensity changes between current and previous instances in time, each pixel 111 stores a representation of the light intensity at the previous instance in time.

More concretely, each pixel 111 stores a voltage Vdiff representing the difference between the photoreceptor signal at the time of the last event registered at the concerned pixel 111 and the current photoreceptor signal at this pixel 111.

To detect events, Vdiff at the comparator node may be first compared to a first threshold to detect an increase in light intensity (ON-event), and the comparator output is sampled on a (explicit or parasitic) capacitor or stored in a flip-flop. Then Vdiff at the comparator node is compared to a second threshold to detect a decrease in light intensity (OFF-event) and the comparator output is sampled on a (explicit or parasitic) capacitor or stored in a flip-flop.

The global reset signal is sent to all pixels 111, and in each pixel 111 this global reset signal is logically ANDed with the sampled comparator outputs to reset only those pixels where an event has been detected. Then the sampled comparator output voltages are read out, and the corresponding pixel addresses sent to a data receiving device.

FIG. 1C illustrates a configuration example of the solid-state imaging device 100 including an image sensor assembly 10 that is used for readout of intensity imaging signals in form of an active pixel sensor, APS. Here, FIG. 1C is purely exemplary. Readout of imaging signals can also be implemented in any other known manner. As stated above, the image sensor assembly 10 may use the same pixels 111 or may supplement these pixels 111 with additional pixels observing the respective same solid angles. In the following description the exemplary case of usage of the same pixel array 110 is chosen.

The image sensor assembly 10 includes the pixel array 110, an address decoder 12, a pixel timing driving unit 13, an ADC (analog-to-digital converter) 14, and a sensor controller 15.

The pixel array 110 includes a plurality of pixel circuits 11P arranged matrix-like in rows and columns. Each pixel circuit 11P includes a photosensitive element and FETs (field effect transistors) for controlling the signal output by the photosensitive element.

The address decoder 12 and the pixel timing driving unit 13 control driving of each pixel circuit 11P disposed in the pixel array 110. That is, the address decoder 12 supplies a control signal for designating the pixel circuit 11P to be driven or the like to the pixel timing driving unit 13 according to an address, a latch signal, and the like supplied from the sensor controller 15. The pixel timing driving unit 13 drives the FETs of the pixel circuit 11P according to driving timing signals supplied from the sensor controller 15 and the control signal supplied from the address decoder 12. The electric signals of the pixel circuits 11P (pixel output signals, imaging signals) are supplied through vertical signal lines VSL to ADCs 14, wherein each ADC 14 is connected to one of the vertical signal lines VSL, and wherein each vertical signal line VSL is connected to all pixel circuits 11P of one column of the pixel array unit 11. Each ADC 14 performs an analog-to-digital conversion on the pixel output signals successively output from the column of the pixel array unit 11 and outputs the digital pixel data DPXS to a signal processing unit. To this purpose, each ADC 14 includes a comparator 23, a digital-to-analog converter (DAC) 22 and a counter 24.

The sensor controller 15 controls the image sensor assembly 10. That is, for example, the sensor controller 15 supplies the address and the latch signal to the address decoder 12, and supplies the driving timing signal to the pixel timing driving unit 13. In addition, the sensor controller 15 may supply a control signal for controlling the ADC 14.

The pixel circuit 11P includes the photoelectric conversion element PD as the photosensitive element. The photoelectric conversion element PD may include or may be composed of, for example, a photodiode. With respect to one photoelectric conversion element PD, the pixel circuit 11P may have four FETs serving as active elements, i.e., a transfer transistor TG, a reset transistor RST, an amplification transistor AMP, and a selection transistor SEL.

The photoelectric conversion element PD photoelectrically converts incident light into electric charges (here, electrons). The amount of electric charge generated in the photoelectric conversion element PD within a predetermined exposure time ET, which is a receiver system parameter SP_Rec of the receiver unit 1020, which will be discussed in all detail below, corresponds to the amount of the incident light.

The transfer transistor TG is connected between the photoelectric conversion element PD and a floating diffusion region FD. The transfer transistor TG serves as a transfer element for transferring charge from the photoelectric conversion element PD to the floating diffusion region FD. The floating diffusion region FD serves as temporary local charge storage. A transfer signal serving as a control signal is supplied to the gate (transfer gate) of the transfer transistor TG through a transfer control line.

Thus, the transfer transistor TG may transfer electrons photoelectrically converted by the photoelectric conversion element PD to the floating diffusion FD.

The reset transistor RST is connected between the floating diffusion FD and a power supply line to which a positive supply voltage VDD is supplied. A reset signal serving as a control signal is supplied to the gate of the reset transistor RST through a reset control line.

Thus, the reset transistor RST serving as a reset element resets a potential of the floating diffusion FD to that of the power supply line. The reset transistor RST is switched by the signal GlobalReset. The time period between respective outputs of the signal GlobalReset may be equivalent to an exposure time ET, which is a receiver system parameter SP_Rec of the receiver unit 1020, which will be discussed in all detail below.

The floating diffusion FD is connected to the gate of the amplification transistor AMP serving as an amplification element. That is, the floating diffusion FD functions as the input node of the amplification transistor AMP serving as an amplification element.

The amplification transistor AMP and the selection transistor SEL are connected in series between the power supply line VDD and a vertical signal line VSL.

Thus, the amplification transistor AMP is connected to the signal line VSL through the selection transistor SEL and constitutes a source-follower circuit with a constant current source 21 illustrated as part of the ADC 14.

Then, a selection signal serving as a control signal corresponding to an address signal is supplied to the gate of the selection transistor SEL through a selection control line, and the selection transistor SEL is turned on.

When the selection transistor SEL is turned on, the amplification transistor AMP amplifies the potential of the floating diffusion FD and outputs a voltage corresponding to the potential of the floating diffusion FD to the signal line VSL. The signal line VSL transfers the pixel output signal from the pixel circuit 11P to the ADC 14. Since the respective gates of the transfer transistor TG, the reset transistor RST, and the selection transistor SEL are, for example, connected in units of rows, these operations are simultaneously performed for each of the pixel circuits 11P of one row. Further, it is also possible to selectively read out single pixels or pixel groups.

The ADC 14 may include a DAC 22, the constant current source 21 connected to the vertical signal line VSL, a comparator 23, and a counter 24.

The vertical signal line VSL, the constant current source 21 and the amplifier transistor AMP of the pixel circuit 11P combine to a source follower circuit.

The DAC 22 generates and outputs a reference signal. By performing digital-to-analog conversion of a digital signal increased in regular intervals, e.g. by one, the DAC 22 may generate a reference signal including a reference voltage ramp. Within the voltage ramp, the reference signal steadily increases per time unit. The increase may be linear or not linear.

The comparator 23 has two input terminals. The reference signal output from the DAC 22 is supplied to a first input terminal of the comparator 23 through a first capacitor C1. The pixel output signal transmitted through the vertical signal line VSL is supplied to the second input terminal of the comparator 23 through a second capacitor C2.

The comparator 23 compares the pixel output signal and the reference signal that are supplied to the two input terminals with each other, and outputs a comparator output signal representing the comparison result. That is, the comparator 23 outputs the comparator output signal representing the magnitude relationship between the pixel output signal and the reference signal. For example, the comparator output signal may have high level when the pixel output signal is higher than the reference signal and may have low level otherwise, or vice versa. The comparator output signal VCO is supplied to the counter 24.

The counter 24 counts a count value in synchronization with a predetermined clock. That is, the counter 24 starts the count of the count value from the start of a P phase or a D phase when the DAC 22 starts to decrease the reference signal, and counts the count value until the magnitude relationship between the pixel output signal and the reference signal changes and the comparator output signal is inverted. When the comparator output signal is inverted, the counter 24 stops the count of the count value and outputs the count value at that time as the AD conversion result (digital pixel data DPXS) of the pixel output signal.

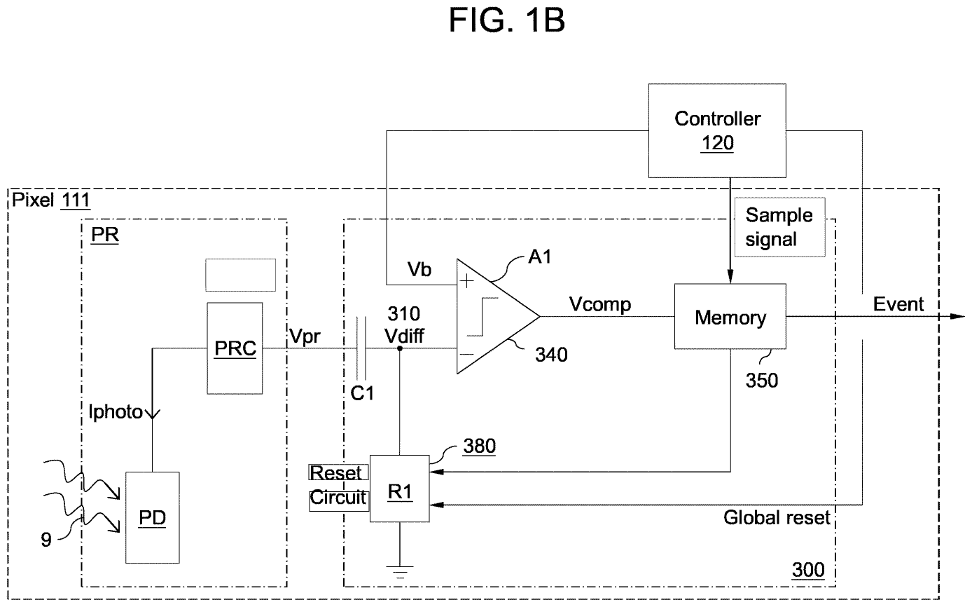

FIG. 2 shows schematically a sensor device 1000 for generating depth information for an object O, i.e. a device that allows deduction of distances of surface elements of the object O or the posture of the object O in three-dimensional space to the sensor device 1000. The sensor device 1000 may be capable to generate the depth information itself or may only generate data based on which the depth information can be established in further processing steps.

The sensor device 1000 comprises a projector unit 1010 configured to illuminate different locations of the object O during different time periods with an illumination pattern. The geometry and the form or kind of the illumination pattern, simply how the illumination pattern is projected to the object O, will be referred as “illumination pattern” IP in the following, which may be a projector system parameter SP_Trans of the projector unit 1010. In particular, the projector unit 1010 is configured to project in a temporally consecutive manner a plurality of different illumination patterns in a projection solid angle PS to the object O, where the projection solid angle PS consists of a predefined number of predetermined solid angles and each illumination pattern is generated by deciding for each of the predetermined solid angles whether or not to illuminate the respective predetermined solid angle by projecting light into it. The projection in a temporally consecutive manner of a plurality of different illumination patterns in a projection solid angle PS to the object O will be referred as “Sequence of illumination pattern” SIP in the following, which may be a projector system parameter SP_Trans of the projector unit 1010.

In the exemplary illustration of FIG. 2 and the following description illumination patterns consisting of lines L will be used, where the positions of the lines L changes with time such that during different time periods different parts of the object O are illuminated with the lines L. In this case the predetermined solid angles have linear or rectangular cross sections and are parallel to each other in a cross-sectional plane. Preferably, the predetermined solid angles are adjacent to each other such that they completely fill the projection solid angle PS. However, the predetermined solid angles may also be separated from each other by a certain distance such that predetermined solid angles are separated by non-illuminated regions.

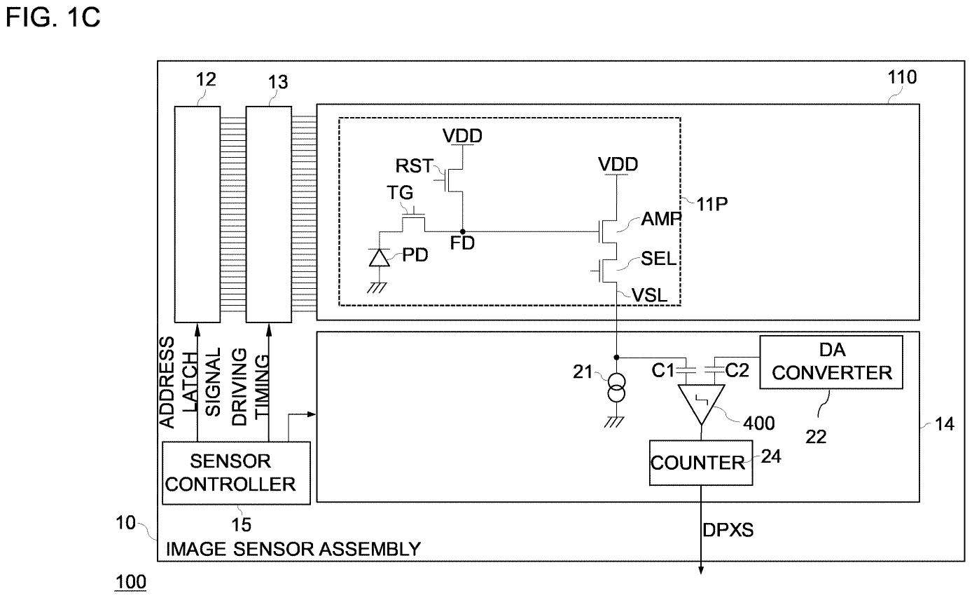

While FIG. 2 shows an example, in which only one line is projected to the object O, also several lines may be projected at the same time, as schematically shown in FIG. 3. Note that the equidistant arrangement of lines in FIG. 3 is only chosen for simplicity. The lines may have arbitrary positions. Also the number of lines, i.e. the number of illuminated predetermined solid angles may change with time.

Although the below description focuses on the line example illustrated in FIGS. 2 and 3, a skilled person readily understands that also other sparse illumination patterns may be used such as checkerboard patterns or even pixel-wise illumination. In all these cases the smallest units that can be illuminated separately form the predetermined solid angles.

The change of the illumination may be effected e.g. by using a fixed light source, the light of which is deflected at different times at different angles. For example, a mirror tilted by a micro-electro-mechanical system (MEMS) might be used to deflect the illumination pattern and/or a refractive grating may be used to produce a plurality of lines. Alternatively, an array of vertical-cavity surface-emitting lasers (VCSELs) or any other laser LEDs might be used that illuminate different parts of the object O at different times. Further, it might also be possible to use shielding optics like slit plates or LCD-panels to produce time varying illumination patterns. The light source may be any kind of light source which is adapted to generate an illumination pattern with sufficient coherence and intensity. The light source may thus be, for example, a VCSEL or an array of VCSELs, or any other laser LED, or an LED, or an array of LEDs, or OLED, or an array of OLEDs, or a power LED, or an array of power LEDs, or a resonant-cavity light emitting diode, RCLED, or an array of RCLEDs, the light pulse intensity of which could be controlled by providing a respective current or power. The light pulse intensity LPI is a further projector system parameter SP_Trans of the projector unit 1010.

It should also be noted that the projector unit 1010 may be arranged such that some points in the field of view of the projector unit 1010 are never illuminated with the illumination patterns.

Alternatively, the illumination pattern sent out from the projector unit 1010 may be fixed, while the object O moves across the illumination pattern. In principle, the precise manner of the generation of the illumination pattern and its movement across the object is arbitrary, as long as different positions of the object O are illuminated during different time periods.

The sensor device 1000 comprises a receiver unit 1020 comprising a plurality of pixels 1025. Due to the surface structure of the object O, the illumination patterns are reflected from the object O in distorted form and forms an image I of the illumination pattern on the receiver unit 1020. The pixels 1025 of the receiver unit 1020 may in principle be capable to generate a full intensity image of the received reflection. More importantly, the receiver unit 1020 is configured to detect on each pixel 1025 intensities of light reflected from the object O while it is illuminated with the illumination pattern, and to generate an event at one of the pixels 1025 if the intensity detected at the pixel 1025 changes by more than a predetermined threshold. Thus, the receiver unit 1020 can act as an event sensor as described above with respect to FIGS. 1A to 1C that can detect changes in the received intensity that exceed a given threshold. Here, positive and negative changes might be detectable, leading to events of so-called positive or negative polarity. Further, the event detection thresholds might be dynamically adaptable and might differ for positive and negative polarities.

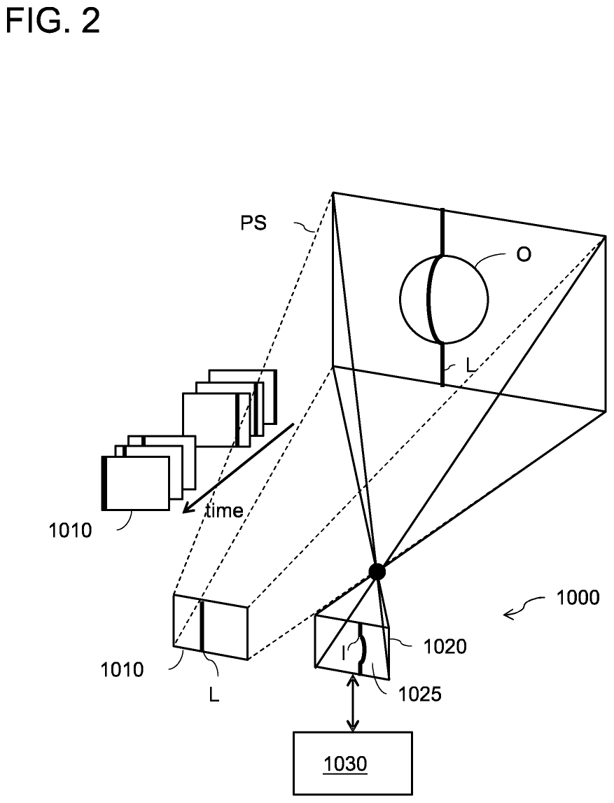

Besides being capable to detect intensities of light reflected from the object O that stem from the illumination with the illumination patterns, the receiver unit 1020 is also capable to detect intensities that stem from illumination with ambient light, and to generate an event at one of the pixels 1025 if the intensity detected at the pixel 1025 changes by more than a predetermined threshold for both kinds of light sources. This is schematically illustrated in FIG. 4, where the receiver unit 120 not only receives and detects the reflected illumination patterns, but also light from external light sources, such as the sun or lamps, that are reflected on the object O.

Here, it should be noted that the reflected ambient light will be mainly visible light, while the light of the illumination patterns may have any wavelengths. Thus, for example both the ambient light and the light of the illumination patterns may be visible light. This will keep the design of the receiver unit 1020 most simple since the pixels can be laid out for a single wavelength range. However, the light of the illumination patterns may also be infrared light, if it is intended that the illumination patterns are not to be seen on the object O. The pixels 1025 of the receiver unit 1020 are then capable to detect infrared light as well as visible light, i.e. they have sensitivity for light having wavelengths between 1,000 μm to 380 nm. Optionally, a filtering optical element that only transmits light around the projector light wavelength can be added before the receiver unit 1020. This will prevent ambient light from reaching the receiver unit 1020 in case this is undesirable. The wavelength Lambda_IP of the projected light of the illumination patterns may be a further projector system parameter SP_Trans of the projector unit 1010.

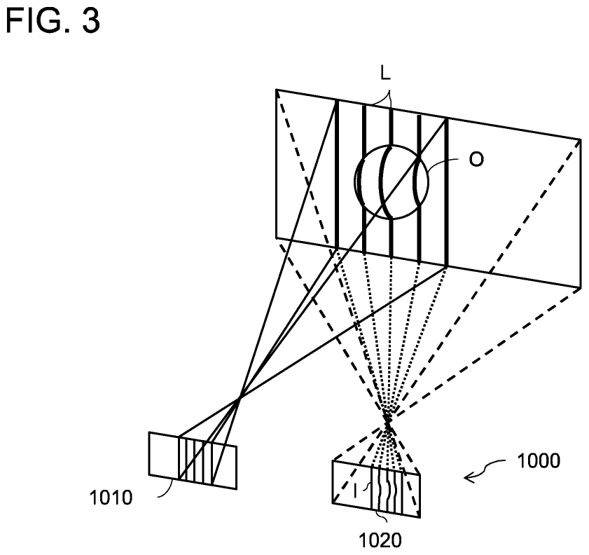

FIG. 5 shows a symbolization of the change of illumination patterns over time as used in the projector unit 1010. Here, the illumination patterns are formed by illuminating 8 different predetermined solid angles, e.g. by projecting lines at 8 different locations onto an object, or by illuminating 8 different (preferably rectangular) areas on the object, which might even have a resolution comparably to those of the pixels 1025 of the reception unit 1020. Of course, the number of different predetermined solid angles might be different. The number of different predetermined angles No_PA may be a further projector system parameter SP_Trans of the projector unit 1010.

Projecting light into one of the 8 predetermined solid angles of FIG. 5 is indicated by a white square, while missing illumination is illustrated by a black square. In a binary representation, illumination/white may be represented by a “1” and missing illumination/black by a “0”. FIG. 5 shows exemplarily a sequence of 5 consecutive illumination periods. This leads then for each of the 8 predetermined solid angles to a code word, CW, having a length of N=5 symbols. The number of consecutive illumination periods No_CIP and the according length of the code word No_CW may be a further projector system parameter SP_Trans of the projector unit 1010. An according representation of changes of illuminations as code words projected to a given predetermined solid angle is particularly adapted to the usage of an event-based vision sensor. In fact, each transition from “0” to “1” in a code word, will trigger a positive polarity event, while transitions from “1” to “0” trigger a negative polarity event. In this manner, the control unit can compare event sequences generated at certain pixels with illumination patterns projected into specific predetermined solid angles. Matching event sequences and code words allows then to identify the optical path of the light of the illumination pattern via the object, i.e. to determine the distance via triangulation.

The control unit 1030 receives all the events generated during a predetermined time period, i.e. the events generated due to illumination by the projector unit 1010 and the events generated due to the illumination with ambient light. The control unit 1030 generates depth information based on all these events.

Here, the control unit 1030 may be any arrangement of circuitry that is capable to carry out the functions described herein. For example, the control unit 1030 may be constituted by a processor. The control unit 1030 may be part of the pixel section of the sensor device 1000 and may be placed on the same die(s) as the other components of the sensor device 1000. But the control unit 1030 may also be arranged separately, e.g. on a separate die. The functions of the control unit 1030 may be fully implemented in hardware, in software or may be implemented as a mixture of hardware and software functions.

The dataset on which the control unit 1030 operates to determine the depth information contains therefore a part that is related to overall shape and texture of the objects (ambient light) and a part dedicated to determining the distance between object (O) and sensor device 1000 (illumination patterns). This increase in information increases the accuracy with which the depth information can be generated. However, since only a single receiver unit 1020 is used, this improvement comes without a raise in costs and/or power consumption.

Moreover, events from ambient light will be generated with a higher frequency than the frequency of changes between differing illumination patterns. This allows refining at high temporal rate and by using the events generated due to the ambient light core estimates made via the events caused by the illumination patterns. For example, in monitoring an object O a distance between sensor device 1000 and the object O may be established with a first frequency by using the events caused by the illumination patterns. From such a measurement it can be established how big the object O looks for a given distance. The events generated by ambient light, which represent basically a two-dimensional image of the observed scene can then be used to determine changes in the apparent size of the object O, which allow to deduce changes of the distance between object O and sensor device 1000. This adaption of the distance can be carried out with a considerably larger frequency than the original distance estimation. Thus, the temporal resolution of the generation of depth information is increased.

Just the same the frequency of the changes of illumination patterns can be lowered to save energy. By using the events generated due to the incident ambient light the temporal resolution of the generation of depth information can still be kept in an acceptable range.

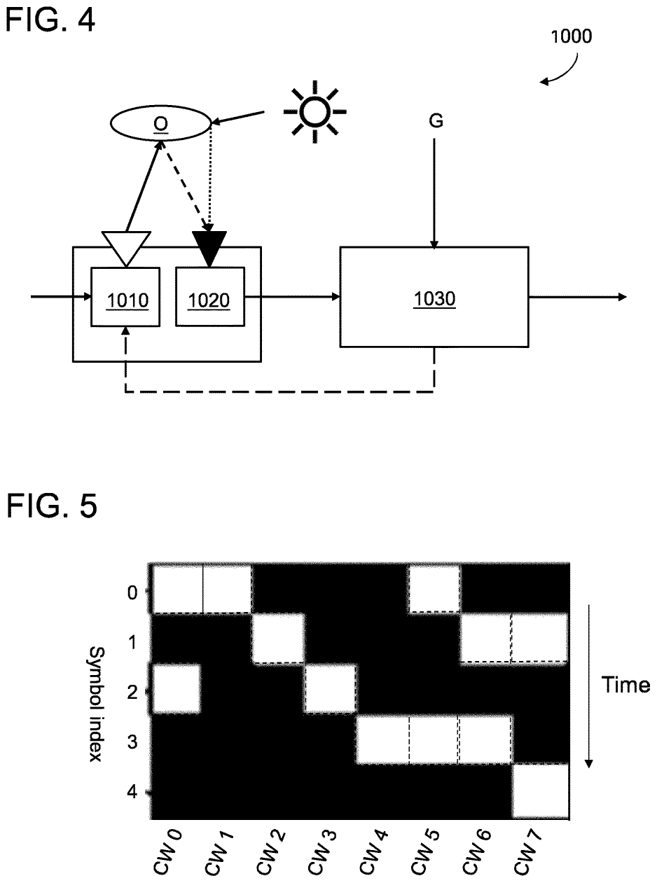

FIG. 6 shows schematically how the control unit 1030 operates on the event data such as to generate the depth information. All the blocks shown in FIG. 6 may be constituted by hardware, i.e. processors or circuitry, or software and/or a mixture thereof.

The control device 1030 receives all the events E generated during the predetermined time period. Further, the control device 1030 is provided from the projector unit 1010 with information P that indicates whether during a given time period within the predetermined time period the projector unit 1010 did not project light on the object O. Alternatively, the control unit 1030 generates the information P itself and controls the projector unit 1010 accordingly, i.e. the control unit 1030 decides when to project the illumination patterns and when not. In this manner, the control unit 1030 is configured to determine whether or not the projector unit 1010 projects light during a given time period into the projection solid angle PS. This might be done in a discriminator block 1032 as shown in FIG. 6.. The given time period for projection or the according illumination duration or the according projection time window ProjTw may be a further projector system parameter SP_Trans of the projector unit 1010.

If, as a first case, the control unit 1030 determines that no light has been projected into the projection solid angle PS during the given time period (“N” in FIG. 6), the control unit 1030 is configured to generate first information by processing the events on the assumption that all events generated during the given time period are caused by ambient light. Of course this assumption is adequate since if no illumination patterns are projected onto the object, events can only be caused by changes in the ambient light. Event processing is therefore executed as if no projector unit 1010 were present. The first information may then be the mere event data, i.e. the position of the event on the receiver unit 1020, its time stamp, and its polarity. Additionally, as indicated by the dashed arrow, metadata M may be added to the event data to generate the first information, e.g. by concatenating event data and metadata M. Here, the metadata may e.g. indicate the bearing vector of the event generating pixel, i.e. the vector pointing from the camera center to the pixel.

On the other hand, if, as a second case, the control unit 1030 determines that light has been projected into the projection solid angle PS during the given time period, the control unit 1030 is configured to generate second information by processing the events on the assumption that all events generated during the given time period are caused by light projected by the projector unit 1010. Thus, if the projector unit 1010 is turned on, the control unit 1030 will operate as if there was no ambient light. The error introduced by this assumption is small enough to be negligible or compensated during further processing the second information.

In the second case, the control unit 1030 operates with the knowledge that information on the distance between the object O and the sensor device 1000 is encoded in the event data and will extract this information on the distance. As shown by the dashed boxes in FIG. 6 this may be done by generating a depth map of the object O based on the obtained events. To this end, a code word extractor module 1033 and a triangulation module 1034 may be provided. The code word extractor module 1033 operates on the known distribution L of the illumination patterns and on the event data E.

Using the code word extractor 1033, the control unit 1030 tries to establish a correspondence between the sequences of positive and negative polarity events received in each pixel 1025 and the known illumination patterns that can be expressed as code words as explained above with respect to FIG. 5. To this end, the events can be accumulated in a temporal histogram per pixel, where time bins of the histogram match the change frequency of illumination patterns. It is then possible to cross correlate the histogram of one pixel (and optionally of its neighboring pixels) with the projected code words. The code word with the maximum correlation will be assumed to have generated the corresponding events. Alternatively, it is also conceivable to implement a neural network that takes as input the histogram of one pixel (and optionally of its neighboring pixel) and directly outputs correlation scores of the different code words or the responsible code word. Of course, any other method that allows to identify the part of the illumination that caused an event sequence on a certain pixel, may be used.

The correlation of pixel 1025 and code word is then forwarded to the triangulation module 1034, which establishes the depth map based on this correlation and the known geometry G of the setup, i.e. the relative positions of projector unit 1010 and receiver unit 1020, by triangulation in an in principle known manner. In particular, since it is known which code word is projected into which solid angle, which pixel 1025 received the reflection of the code word, and how large the distance between projector unit 1010 and receiver unit 1020 is, the distance between sensor device 1000 and object O can be determined. The distance or depth value DV will be referred later as “application task output” ATO, which is an example of a task output of the sensor device 1000, which can be optimized by changing respective system parameters SP, such as receiver system parameters SP_Rec or projector system parameters SP_Proj as discussed above.

In this manner, the control unit 1030 identifies in the second case, i.e. projector on, based on the temporal and spatial distribution of the events, which events were caused by which illumination pattern, and generates based on this identification and the known geometric relation of projector unit 1010 and receiver unit 1020 a depth map of the object O as the second information. The second information may contain in addition the event data E and the metadata M.

It is to be understood that any other method for obtaining second information can be used, as long as the second information represents somehow the fact that due to the usage of the illumination patterns knowledge about the distance between sensor device 1000 and object O has been introduced. For example, the histograms showing event numbers over time for each pixel 1025 can be directly compared with histograms pre-derived for specific illumination conditions and object distances. From this comparison, the distance can be directly deduced, if the measured histogram matches one of the pre-derived histograms. The comparison can be done by a neural network that has been trained based on simulated results of illuminating object at varying distances with varying illumination patterns.

The first and the second information are then provided to a predictor module 1031 of the control unit 1030. The predictor module 1031 generates the depth information based on both the first information and the second information. In particular, the predetermined time interval that is used to determine the depth information will most often contain both, given time periods without projection of illumination patterns, and given time periods with projection of illumination patterns. The predetermined time interval that is used to determine the depth information, also referred as detection time window DetTw, may be a further receiver system parameter SP_Rec of the receiver unit 1020.

The predictor module 1031 gathers the information generated for each of these given time periods and provides depth information upon input of either first or second information. In this manner, it is e.g. possible to provide depth maps also for time instances at which the projector unit 1010 is turned off, by updating the depth maps contained in the second information based on the first information. Moreover, it is possible to derive more than the pure distance information from the depth maps. The depth information may also include such additional information. For example, in a hand tracking application, besides merely calculating the depth map of a hand, the predictor unit 1031 may recognize a specific gesture or sign made with the hand. In this manner, refined information can be obtained without increase of the production cost or the energy consumption.

The second information contains basically a depth map of the object O, i.e. three-dimensional information. This can on the one hand be used as a basic information regarding distance of an object O that is then updated based on the two-dimensional first information. On the other hand, the depth map contained in the second information can also be used to correct and thus refine state variables derived based on the first information, in particular, if for a certain time period only first information is available. First and second information therefore support each other such that omission of the second information, i.e. switch off of the projector for power saving, does not become critical for the accuracy of the state variables.

Here, it should be noted that although the state variables might be constituted by a mere depth map, the state variables SV may also take a form that is not as easy to understand for a human as a depth map. As explained above, the state variables are set such as to optimize the processing and will most often have the form of mere datasets that do not allow a direct deduction of the meaning encoded therein. However, for the simple case that only a depth map is of interest as the depth information, the state variables may constitute such a depth map. But if more information is requested, as e.g. the orientation of an object (such as a hand) in space, the recognition of a specific gesture, the classification of a facial expression, or the like, the state variables will take a form that makes processing of this request most reliable and fast. The state variables SV will be referred later as “application task output” ATO, which is a further example of a task output of the sensor device 1000, which can be optimized by changing respective system parameters SP, such as receiver system parameters SP_Rec or projector system parameters SP_Trans as discussed above.

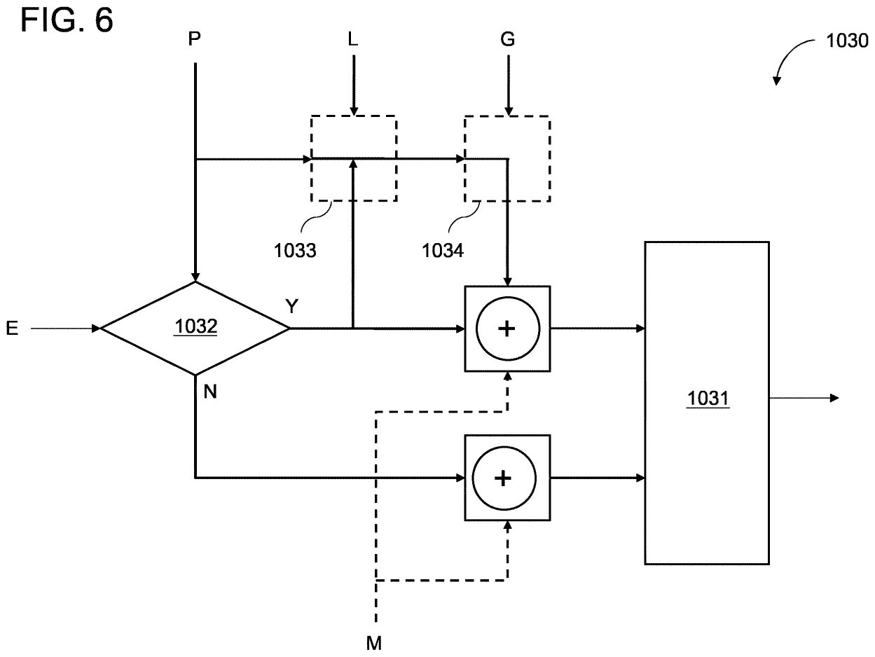

In the above description it has been assumed that different illumination patterns are projected into all solid angles. However, illumination patterns may be repeated after a given number of solid angles. This is shown exemplary in FIG. 7 where code word blocks A and B are identical. In this case, there will be an ambiguity in that detected event sequences will match the corresponding illumination pattern in each of the blocks. However, this ambiguity can be resolved by the control unit 1030 by recurring to the fact that only for one match a depth map showing a meaningful result will be generated. For example, if the desired depth information relates to the position of a hand in three-dimensional space, it can be checked which of the generated depth maps will show a hand, thus eliminating wrong matches. Thus, by using context information and scene priors, ambiguities can be resolved, which allows usage of repeating illumination patterns. This makes the design of the projector unit 1010 simpler.

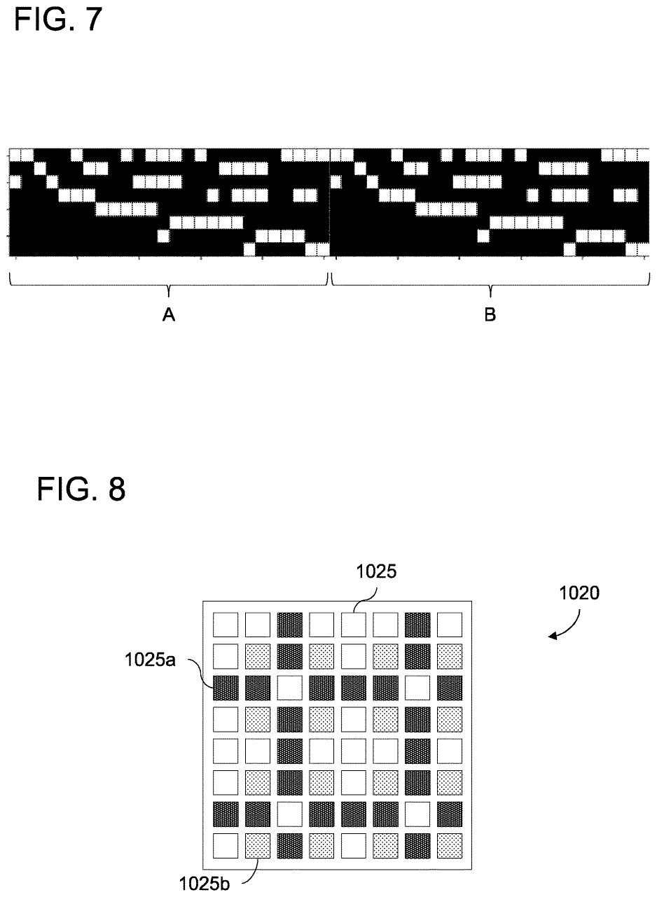

In the forgoing description reference has been made to a receiving unit 1020 in which all pixels 1025 are in principle capable to receive illumination light and ambient light. However, as schematically illustrated in FIG. 8, it might also be possible to use a receiver unit 1020 that comprises first pixels 1025a that detect only intensities of light reflected from the object O that stem from illumination with ambient light and second pixels 1025b that detect only intensities of light reflected from the object O that stem from the illumination with the illumination patterns. In particular when the light used for illumination has a wavelength that differs from the wavelengths of ambient light, the first pixels 1025a may be provided with color filters that only transmit ambient light, while the second pixels 1025b are provided with color filters that transmit only the illumination light. Of course, as illustrated in FIG. 8 it is still possible to use pixels 1025 capable to receive illumination light as well as ambient light. In this case, the first pixels 1025a will always contribute to the generation of the first information, while the second pixels 1025b will always contribute to the generation of second information. Accordingly, first and second information may also be provided in parallel to the predictor module 1031. If pixels 1025 capable to operate based on illumination light and based on ambient light are present, these pixels 1025 will alternatively contribute to the generation of first and second information as explained above. In this manner, errors occurring due to interpreting ambient light generated events as illumination light generated events can be avoided or at least suppressed. As explained above, the receiver unit 1020 may not only be configured to generate events but may also be configured to generate for each pixel 1025 intensity information indicating the intensity of the light reflected from the object O, i.e. to generate a normal RGB or grayscale frame image of the observed scene.

As schematically indicated by the dashed arrow in FIG. 4, the control unit 1030 may be configured to turn the projector unit 1010 on and off and/or to control the projection solid angle PS of the projector unit 1010 based on the depth information. As explained above, once a distance to the observed object O has been established using the projected light, it may be possible to generate the depth information based on the two-dimensional information obtainable via ambient light. This makes the projection of further illumination patterns superfluous for a certain time period. Only, if the control unit 1030 determines that the accuracy and/or reliability of the depth information (depth map, three-dimensional orientation, gesture classification or the like) is no longer good enough, the projector unit 1010 is turned on again.

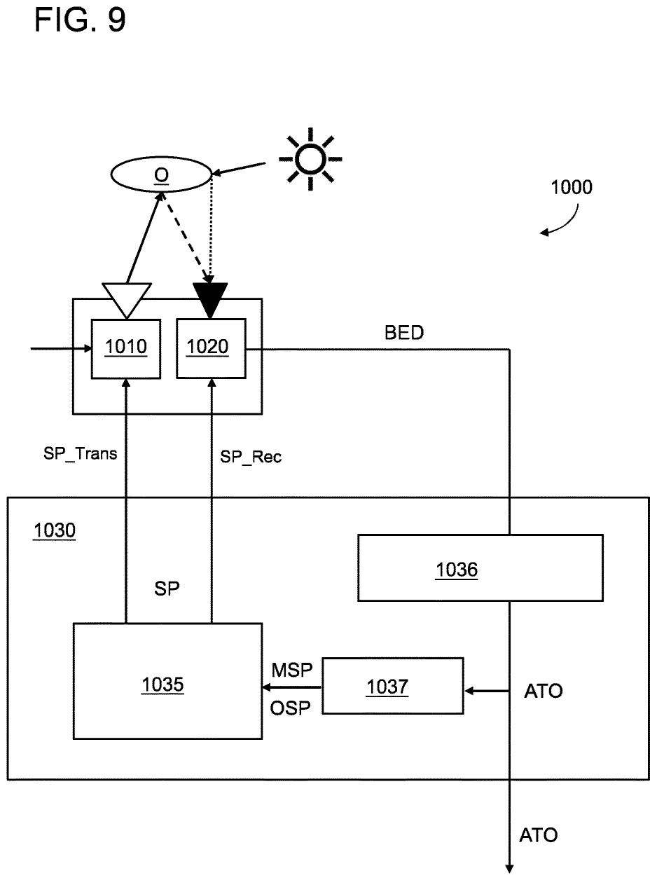

FIG. 9 shows schematically the sensor device 1000 for generating depth information for an object O, which comprises the projector unit 1010 that is configured to project illumination patterns to the object O and a receiver unit 1020 that is configured to detect intensities of light reflected from the object O stemming from the illumination with the illumination patterns and/or from illumination with the ambient light.

As already discussed in all detail, with regard to FIGS. 1A to 5, the projector unit 1010 is configured to project in a temporarily consecutive manner a plurality of different illumination patterns SIP in a projection solid angle PS to the object O, where the projection solid angles PS consists of a predefined number of predetermined solid angles and each illumination pattern IP is generated by deciding for each of the predetermined solid angles whether or not to illuminate the respective predetermined solid angle by projecting light into it. The light projected by the projector unit 1010 may be infrared light and the ambient light is visible light. Furthermore, the receiver unit 1020 comprises a plurality of pixels 1025, wherein the receiver unit 1020 is configured to detect on each pixel 1025 intensities of light reflected from the object O stemming from the illumination with the illumination patterns and/or from illumination with ambient light. Herein, the receiver unit 1020 is configured to generate an event at one of the pixels 1025 if the intensity detected at the pixel 1025 changes by more than a predetermined threshold.

The control unit 1030 is configured to generate the depth information based on all events generated during a predetermined time period. The control unit 1030 may be constituted by a processor. Thus, as can be seen from FIG. 9, further units 1036 to 1037 should be interpreted as functional units of the processor, which can be implemented on a hardware level in the processor architecture or may be implemented as machine language instructions based on a low-level programming language to perform an optimizing process of the system parameters of the structured light system in real time. However, the invention should be not regarded as being restricted to a hardware implementation of the units 1036 to 1037, the functionality of these units could be also implemented by using any code, even on a high-level programming language. In any case, a deep level implementation can be regarded as an advantageous implementation.

In detail, the control unit 1030 further comprises, next to possibly further functional units, a system parameter unit 1035 that is configured to set system parameters SP of the sensor device 1000, a decoder unit 1036 that is configured to generate the depth information based on the illumination patterns reflected from the object O and detected by the receiver unit 1020, and an optimizer unit 1037 that is configured to determine system parameter SP changes that maximize the depth sensing performance in current environmental conditions. The projector unit 1010 and the receiver unit 1020 are controlled by system parameters SP, wherein the system parameters SP include projector system parameters SP_Trans of the projector unit 1010 and/or receiver system parameters SP_Rec of the receiver unit 1020. These system parameters SP_Trans and SP_Rec are set by the system parameter unit 1035 to control the projector unit 1010 and the receiver unit 1020, respectively, in order to optimize the system parameters SP in real time to keep a constant performance across many conditions, while maintaining the fast performance of the sensor device 1000. As already discussed above, the performance of the sensor device 1000 depends on the current operation environmental conditions, such as scene or respective distances of the object O to the sensor device 1000. The performance of the sensor device 1000 degrades significantly if it operates in a condition different to the one it was optimized for. Thus, the auto-tunable EVS-based STL-system is adapted to have an optimized depth sensing performance in changing environments such as virtual reality or augmented reality applications.

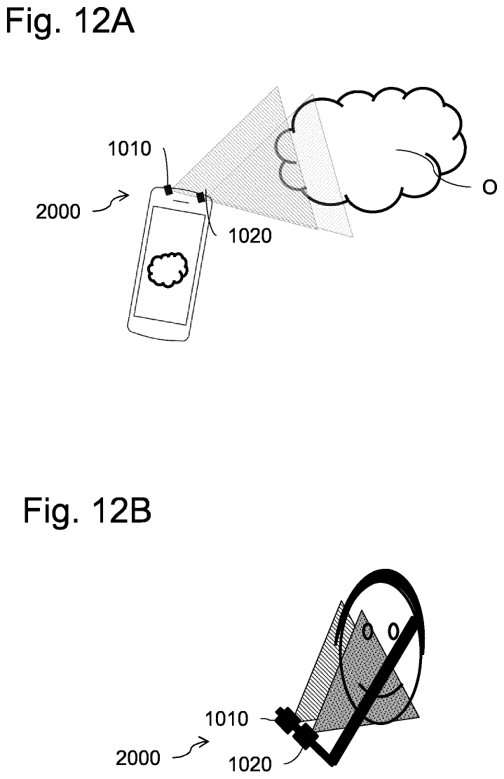

As can be seen from FIG. 9, the control unit 1030 comprises the decoder unit 1036, which is configured to determine an application task output ATO such as a depth map or a depth information based on the illumination patterns reflected from the object O and detected by the receiver unit 1020. The decoder unit 1036 is adapted to obtain the pattern code that maximally correlates with the observed event sequence. The correlation is computed using binary arithmetic while taking advantage of the binary representation of the data and code. The output variable such as the depth information is then determined by the decoder unit 1036 from the maximally correlating code. Thus, the decoder unit 1036 is adapted to determine the task output variable such as the depth information based on the input binary event grid data BED to generate an application task output ATO. The application task output ATO is then further processed to be used in various applications such as autonomous driving or augmented reality applications, as will be discussed below with regard to FIGS. 12A, 12B, 13, 14 and 16 to 19.

The application task output ATO being output from the decoder unit 1036 is further fed back and input to the optimizer unit 1037 that is configured to determine the changes in the system parameters SP that will maximize the system performance in the current conditions. To optimize at least one system parameter SP of the sensor device 1000, the optimizer unit 1037 is adapted to control the system parameter unit 1035 to change respective system parameters SP as instructed by the optimizer unit 1037. In order to perform this optimizing process of the system parameters SP, the optimizer unit 1037 controls the system parameter unit 1035 to set modulated system parameters MSP to be used as system parameters SP_Trans of the projective unit 1010 and SP_Rec of the receiver unit 1020. The optimizer unit 1037 is adapted to repeat the optimization process in order to perform this process for different system parameters sequentially or at the same time while converting the changed system parameters to finally reach optimized system parameters OSP which are adapted to enable the decoder unit 1036 to output an application task output ATO ensuring a maximized depth sensing performance in current environmental conditions.

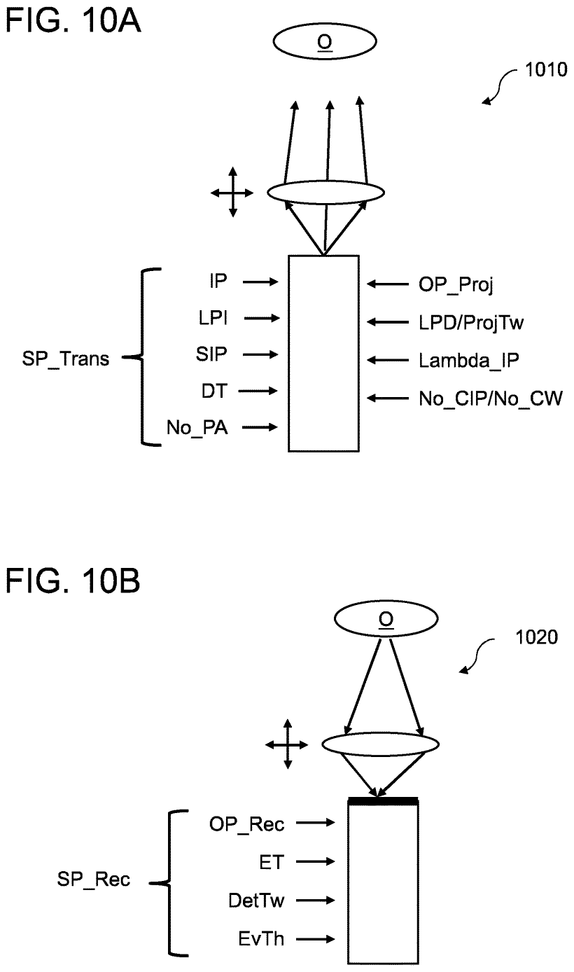

The optimizing process of the system parameters will be now discussed with regard to FIGS. 10A, 10B, 11, 15A and 15B. As already emphasized above, the sensor device 1000 and the method for operating the sensor device 1000 is adapted to provide an EVS-based STL-system with real time adaption of internal behavior (e.g. illumination pattern, laser power, pulse duration, EVS threshold, or optical parameters such as a focus position) to environment. Herein, the EVS-based STL system comprises as a receiver the EVS sensor, and as a transmitter, a laser or LED, which are controlled by the system parameters SP including various transmitter or projector settings or receiver sensor settings.

As can be seen from FIG. 10A, the projector unit 1010 has various projector unit settings or projector unit parameters SP_Trans, which have been discussed above with regards to FIG. 1A to 4. In detail, the projector unit 1010 may be a transmitter comprising a series of one or multiple light sources placed in an array arrangement at specific locations that can either be scanned by an active optical element or turned off and on sequentially. Each light source is adapted to emit a pulse of light at a specific time, for a specific duration, at a specific power. It shall be emphasized that the projector system parameters SP_Trans discussed in the following are only examples of system parameters to illustrate the functionality of the sensor device 1000 and the optimizer unit 1037.

Such examples of projector system parameters SP_Trans may be the illumination pattern IP, the light pulse intensity LPI (which may be the maximum intensity of the light pulse), the light pulse duration or projection time window LPD/ProjTw (which may be the duration of each light pulse), the sequence of illumination patterns SIP (which may be the exact sequence of pulses that each light source emits, defining a binary code that identifies it), the wavelength of the illumination light Lambda_IP, the number of different predetermined angles No_Pa, the number of consecutive illumination patterns No_CIP or the according length of the code word CW, indicated No_CW, or optical parameters OP_Proj of the projector unit 1010 such as a lens position or further focal parameters of the optical system of the projector unit 1010. A further example of a projector system parameter SP_Trans may be the delay time DT between the start of a time slot and the start of the light pulse. Thus, the projector system parameters SP_Trans may be, for example, selected from a list comprising an illumination pattern IP, a sequence of illumination patterns SIP, a light pulse duration LPD, and a light pulse intensity LPI.

As can be seen from FIG. 10B, the receiver unit 1020 can be implemented as an EVS receiver that is adapted to capture incoming light through an imaging optic comprising an adjustable lens, converts it to a current and performs the logarithm and internally keeps track of changes in this value. When a change in log-intensity reaches a specific threshold, increasing or decreasing its value, it fires a positive or negative event, respectively. The times at which the receiver unit 1020 is active can be controlled and synchronized to the projector unit 1010. The binary code emitted by the projector unit 1010 is directly converted to a binary code at the receiver unit 1020, without the need of signal processing. Although the receiver unit 1020 may have various parameter settings, the following receiver system parameters SP_Rec should be discussed as examples. For example, the focal position of the imaging lens may be, next to further optical parameters, an optical parameter OP_Rec of the receiver unit 1020. In addition, the thresholds EvTh as already discussed above, which reflect the minimum changes in log-intensity to fire an event, may be used as a receiver system parameter SP_Rec. In addition, the detection time window DetTw also discussed above, which reflects the time at which the sensor is active, may be part of the receiver system parameter set SP_Rec. Furthermore, the exposure time ET also discussed above may be part of the receiver system parameter set SP_Rec. Thus, the receiver system parameters SP_Rec can be, for example, selected from a list comprising an optical parameter OP_Rec of the optical system of the receiver unit 1020, an exposure time ET, a detection time window DetTw, and event thresholds EvTh.

The system parameters SP as discussed above with regard to FIGS. 10A and 10B should not be regarded as being restrictive for the complete set of system parameters SP of the sensor device 1000, which could be optimized by the optimizer unit 1037 to maximize the depth sensing performance of the sensor device 1000. The nature of the system parameters SP could be binary (such as switching between two different modes, for example, switching between generating first information or second information as discussed above), could be integer (such as a consecutive numbering of different illumination patterns in an illumination pattern sequence SIP), or could be real numbers (such as the focal position of the imaging lens, or the wavelength of the illumination pattern projected to the object O from the projector unit 1010, or the laser power LPI of the light source of the projector unit 1010). Herein, it is necessary that the respective system parameter can be changed or modulated and is not a fixed value or fixed setting of the projector unit 1010 and/or the receiver unit 1020.

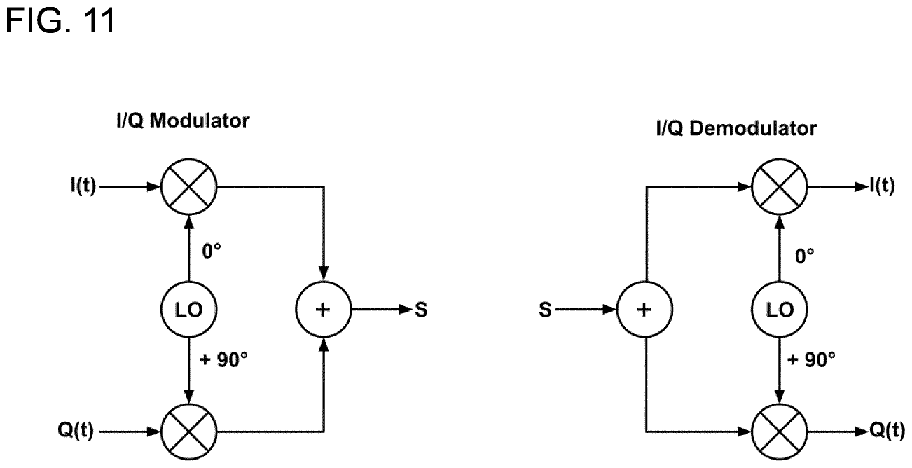

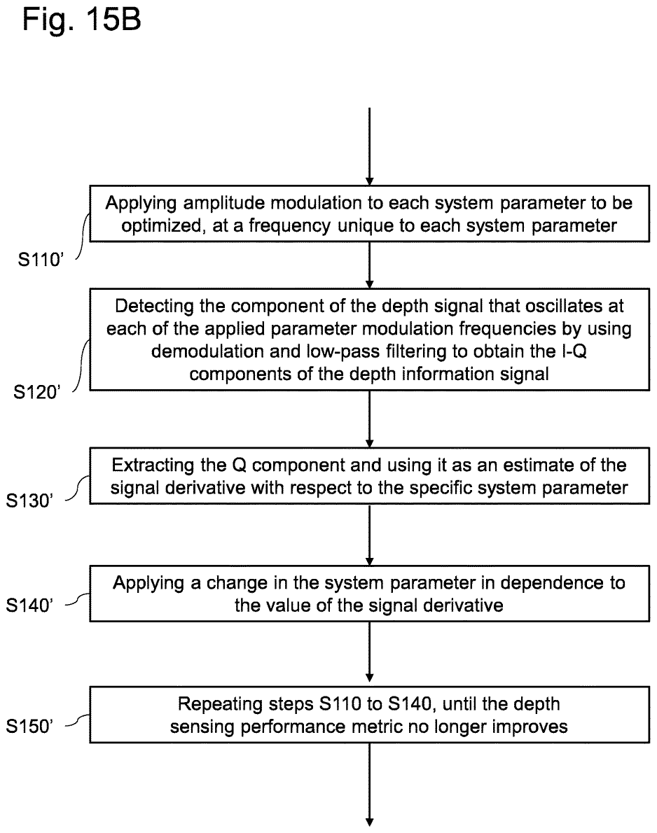

The functionality of the optimizer unit 1037 shall be discussed concerning the illustrative I/Q-modulation/demodulation scheme as depicted in FIG. 11 and related to the method steps executed by the optimizer unit 1037 as shown in FIGS. 15A and 15B. In detail, the optimizer unit 1037 is configured to determine the system parameter SP changes by executing the following steps as shown in FIG. 15A. First, in a step as 110, a modulation MSP is applied to a system parameter SP to be optimized at a specific frequency. Then, in step S120, I-Q components of the chosen optimization objective function, derived from the depth information signal ATO at the decoder unit 1036 that oscillates at the applied modulation frequency are detected. Then, in step S130, the Q component is extracted, and it is used as an estimate of the signal derivative with respect to the system parameter SP to be optimized. Then, in step S140, a change in a system parameter is applied in dependence to the value of the signal derivative. The steps S110 to S140 as discussed above, can be repeated according to a step S150, until the depth sensing performance metric no longer improves.

While the method steps S110 to S140 are focused to optimize a certain system parameter and to repeat this process for further system parameters SP, the following method, which is executed by the optimizer unit 1037, is adapted to optimize a plurality of system parameters SP at the same time. In detail, as shown in FIG. 15B, the optimizer unit 1037 is configured to determine the system parameters SP changes by executing the following steps. First, in step S110′, amplitude modulation MSP is applied to each system parameter SP to be optimized, at a frequency unique to each system parameter SP. Then, in a step S120′, the component of the depth information signal of the decoder unit 1036 that oscillates at each of the applied parameter modulation frequency by using demodulation and low-pass filtering is detected to obtain the I-Q components of the depth information signal. Then, in step S130′, the Q component is extracted and it is used as an estimate of the signal derivative with respect to the specific system parameter SP. Then, in step S140′, a change in the system parameter SP is applied in dependence to the value of the signal derivative. As already mentioned with regard to the method steps S110 to S140 above, the optimizer unit 1037 can also be configured to repeat the steps S110′ to S140′ in a step S150′, until the depth sensing performance metric of all system parameters SP to be optimized no longer improves. Herein, the optimizer unit 1037 may be configured to apply a change in the system parameter SP proportional to the negative value of the signal derivative. The control unit 1030 is thus configured to execute the methods as described above and as shown in FIG. 15A und 15B.

In other words, the optimizer unit 1037 is adapted to determine the optimum parameters of the system of the sensor device 1000 to achieve the best performance for the output task or application task output ATO such as depth sensing. The optimizer unit 1037 is adapted to receive as input the ATO signal or depth sensing signal from the receiver unit 1020 and the decoder unit 1036 and is further adapted to produce as output the control signals to be applied to the system parameter unit 1035 to set respective system parameters SP for the projector unit 1010 and the receiver unit 1020. The optimizer unit 1037 is adapted to apply a small amplitude modulation to each parameter to be optimized, at a frequency unique to each parameter. Herein, the term “small amplitude modulation” shall be understood as a modulation amplitude applied as high as necessary to detect any resulting modulation of the application task output ATO signal and at the same time small enough to enable the process of optimization of the respective system parameters SP. Thus, the modulation amplitude may be for real number value system parameters SP in a range between 1% and 30% of the system parameter SP value, or between 1% and 20% of the system parameter SP value or between 1% and 10% of the system parameter SP value. In case of an integer number system parameter SP value, the modulation of such a parameter may be a modulation to neighboring integer numbers of the respective system parameter SP integer number. In case of a binary system parameter SP value, the modulation will be also a binary modulation. The amplitude modulation function may be any kind of periodic function including a rectangular function, a sinus function, a triangular function, a sawtooth function, a step function, a delta function, or any function having a periodic course. In case of a real number system parameter SP value, the implementation of a sinus function is preferred since such a function has an optimal harmonic or distortion factor and thus an Orthogonal Frequency Division Multiplexing, OFDM, approach as proposed by the method steps S110′ to S150′ can be implemented easily by having narrow orthogonal frequency bands. It shall be emphasized that the above ranges of modulation amplitudes are merely put as examples. The final chosen modulation depth or modulation amplitude would be a system design parameter that is hard to specify precisely as a predetermined parameter variation for each parameter. The above ranges should thus be understood as a first approach, but in practice the variation or modulation may be very different for each parameter.

Concerning the frequency range of the small amplitude modulation function or amplitude modulation function to each system parameter SP to be optimized, the frequency should be at least small enough to prevent any distortion or beat frequency effects in case the functionality of the sensor device 1000 is based on certain clock frequencies. Thus, the amplitude modulation frequency should be at least lower than any of the clock frequencies of the operating clock of the receiver unit 1020 and/or the projector unit 1010 and/or the control unit 1030 of the sensor device 1000. Furthermore, the amplitude modulation frequency should be at least high enough to ensure a real time optimizing process of the system parameters SP to prevent longtime integration periods of the lock-in process of the I-Q modulator/demodulator-unit in the optimizer unit 1037. In particular, the frequency should be fast enough to allow for a fast optimization loop, but slower than the response of the entire system. A frequency meeting the “fast enough” criterium depends on the application, so it may be kept as low as 1 Hz. Fast EVS-based systems could operate as fast as 100 kHz. So, the “low enough” criterium may be specified at least a few tens of kHz as the higher range value. Thus, the frequency of the amplitude modulation may be in a range between 0,1 Hz to 100 kHz, or in a range between 0.5 Hz to 50 kHz, or in a range between 1 Hz and 10 kHz.

The amplitude modulation to each system parameter SP to be optimized is part of an I/Q-modulator and I/Q-demodulator process, as shown in FIG. 11. In this IQ modulation and demodulation scheme, LO is the local oscillator, the carrier wave being modulated, I(t) and Q(t) are the time-series data for the in-phase and quadrature components, and S is the signal. In detail, the optimizer unit 1037 is adapted to detect the component of the depth signal or application task output ATO signal, illustrated in FIG. 11 as signal S, that oscillates at each of the applied parameter modulation frequencies, using the I/Q demodulator and a low-pass filtering to obtain the I-Q components of the ATO signal S. Herein, the Q (out-of-phase) component is extracted and used as an estimate of the signal derivative with respect to the specific system parameter SP. The optimizer unit 1037 is adapted to apply a change in the system parameter SP proportional to the negative value of the ATO signal derivative. a The change in the system parameter SP is a system design parameter and thus hard to define as a fixed value or value range. The change value also strongly depends on the chosen system parameter. The change may be in a range between 0.1% to 70% of the negative value of the ATO signal derivative or 0.5% to 60% of the negative value of the ATO signal derivative or can be 1% to 50% of the negative value of the ATO signal derivative. It shall be further emphasized that the actual percentage value could also be adaptative. Or there could be a time-dependent value, that decreases throughout the optimization prosses. Also, other optimization schemes, e.g. involving momentum, could be used, like those applied in machine learning. The above process may be then repeated, until the ATO sensing performance or the depth sensing performance metric no longer improves. As each parameter is modulated-demodulated at a specific frequency, they can all be optimized in parallel. Thus, a sensor device 1000 is presented which may include an EVS sensor, wherein the system parameters SP such as the illumination pattern or laser illumination parameters change over time to cope with different conditions.

In the following exemplary fields of use of the sensor device 1000 presented above will be discussed briefly.

FIGS. 12A and 12B show schematically camera devices 2000 that comprise the sensor device 1000 described above. Here, the camera device 2000 is configured to generate depth information on a captured scene containing the object O in the manner described above.

FIG. 12A shows a smart phone that is used to obtain depth information such as a depth map of an object O. This might be used to improve augmented reality functions of the smart phone or to enhance game experiences available on the smart phone. FIG. 12B shows a face capture sensor that might be used e.g. for face recognition at airports or boarder control, for viewpoint correction or artificial makeup in web meetings, or to animate chat avatars for web meeting or gaming. Further, movie/animation creators might use such an EVS-enhanced face capture sensor to adapt animated figures to real live persons.

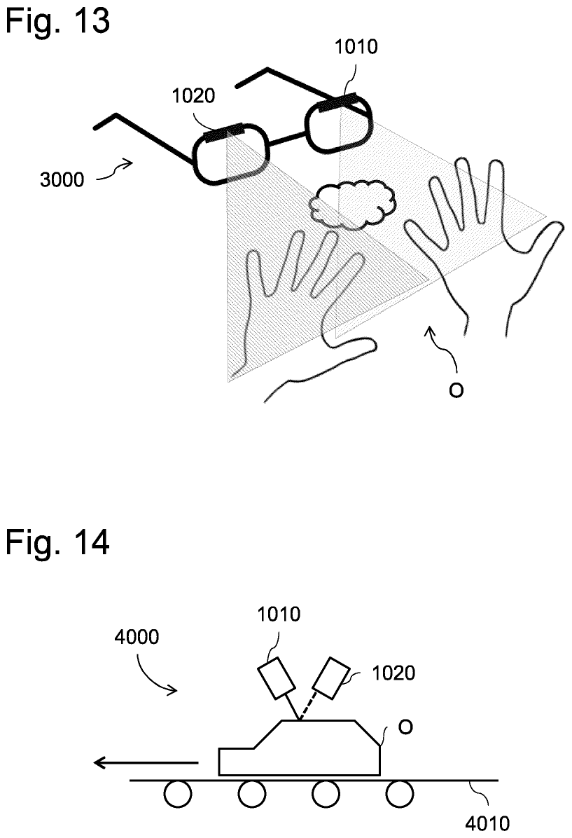

FIG. 13 shows as further example a head mounted display 3000 that comprises a sensor device 1000 as described above, wherein the head mounted display 3000 is configured to generate depth information of an object O viewed through the head mounted display 3000 as described above. This example might be used for accurate hand tracking or gesture recognition in augmented reality or virtual reality applications, e.g. in aiding complicated medical tasks.

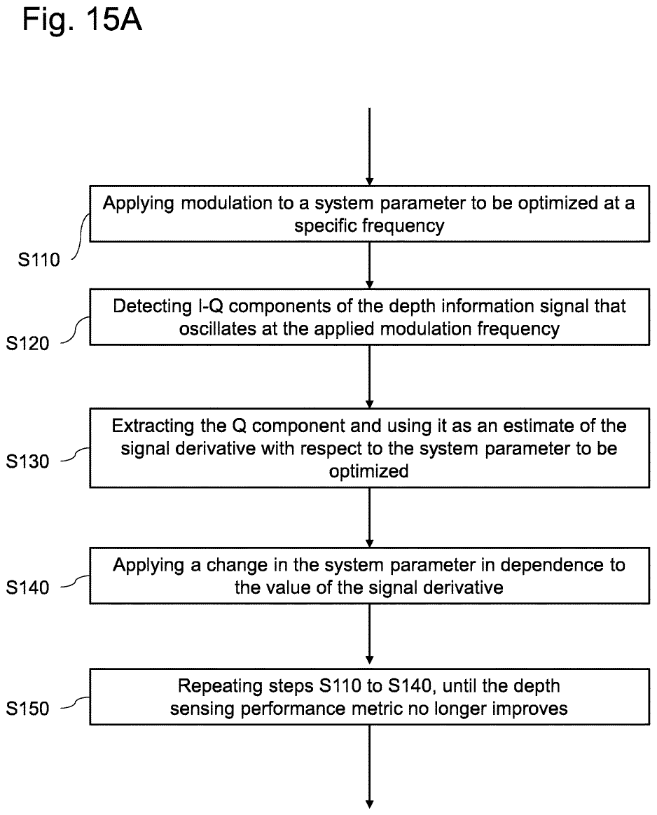

FIG. 14 shows schematically an industrial production device 4000 that comprises a sensor device 1000 as described above, wherein the industrial production device 4000 comprises means 4010 to move objects O in front of the projector unit 1010 in order to (partly) achieve the projection of the illumination pattern onto different locations of the objects O, and the industrial production device 4000 is configured to generate depth information for the objects O based on the positions of the images of the illumination patterns. This application is particularly adapted to EVS-enhanced depth sensors, since conveyor belts constituting e.g. the means 4010 to move objects O have a high movement speed that allows generation of depth information only if the receiver unit 1020 has a sufficiently high time resolution. Since this is the case for the EVS-enhanced sensor devices 1000 described above accurate and high-speed depth maps of industrially produced objects O can be obtained that allows fully automated, accurate, and fast quality control of the produced objects O. The depth information may contain a depth map and/or a classification of object position on the conveyor belt, information on deviations from desired production standards, error classification and the like.

FIG. 15A summarizes the steps of a method for generating depth information for an object O with a sensor device 1000 described above. The method for operating a sensor device 1000 for generating depth information for the object O comprises:
At S110, applying a modulation to a system parameter to be optimized at a specific frequency,
At 120, detecting I-Q components of the depth information signal of the decoder unit that oscillates at the applied modulation frequency,
At S130, extracting the Q component and using it as an estimate of the signal derivative with respect to the system parameter to be optimized,
At S140, applying a change in the system parameter in dependence to the value of the signal derivative, and
At S150, repeating steps S110 to S140, until the depth sensing performance metric no longer improves.

In this manner the above-described enhancement in accuracy and reliability of event-based generation of depth information can be obtained. Further, a constant performance across many conditions could be achieved, while maintaining the fast performance of an EVS sensor.

FIG. 15B summarizes the steps of another method for generating depth information for an object O with a sensor device 1000 described above. The method for operating a sensor device 1000 for generating depth information for the object O comprises:
At S110′, applying amplitude modulation to each system parameter to be optimized, at a frequency unique to each system parameter,
At S120′, detecting the component of the depth information signal of the decoder unit that oscillates at each of the applied parameter modulation frequencies by using demodulation and low-pass filtering to obtain the I-Q components of the depth information signal,
At S130′, extracting the Q component and using it as an estimate of the signal derivative with respect to the specific system parameter, and
At S140′, applying a change in the system parameter in dependence to the value of the signal derivative.
At S150′, repeating steps S110 to S140, until the depth sensing performance metric no longer improves.

In this manner the above-described enhancement in accuracy and reliability of event-based generation of depth information can be obtained. Further, a constant performance across many conditions could be achieved, while maintaining the fast performance of an EVS sensor.

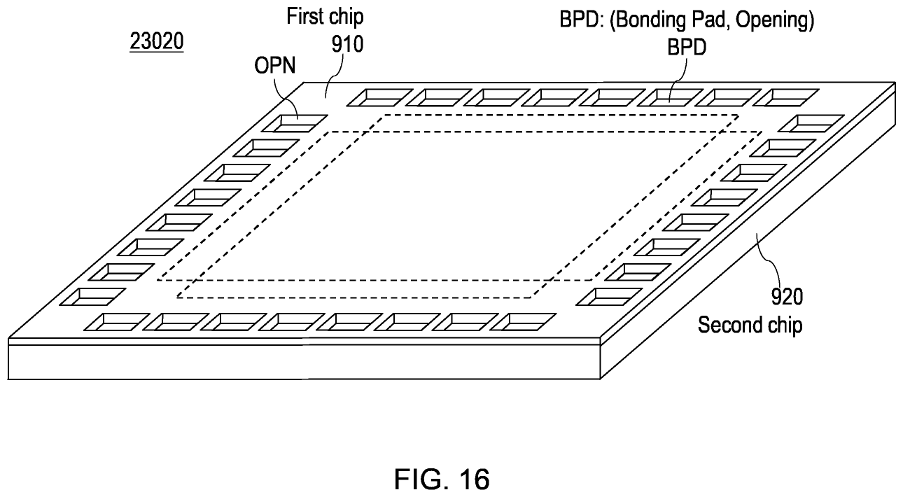

FIG. 16 is a perspective view showing an example of a laminated structure of a solid-state imaging device 23020 with a plurality of pixels arranged matrix-like in array form in which the functions described above may be implemented. Each pixel includes at least one photoelectric conversion element.

The solid-state imaging device 23020 has the laminated structure of a first chip (upper chip) 910 and a second chip (lower chip) 920.

The laminated first and second chips 910, 920 may be electrically connected to each other through TC(S)Vs (Through Contact (Silicon) Vias) formed in the first chip 910.

The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel, e.g., the photoelectric conversion elements arranged in array form. For example, the first chip 910 may include only the photoelectric conversion elements.

Alternatively, the first chip 910 may include further elements of each photoreceptor module. For example, the first chip 910 may include, in addition to the photoelectric conversion elements, at least some or all of the n-channel MOSFETs of the photoreceptor modules. Alternatively, the first chip 910 may include each element of the photoreceptor modules.

The first chip 910 may also include parts of the pixel back-ends 300. For example, the first chip 910 may include the memory capacitors, or, in addition to the memory capacitors sample/hold circuits and/or buffer circuits electrically connected between the memory capacitors and the event-detecting comparator circuits. Alternatively, the first chip 910 may include the complete pixel back-ends. With reference to FIG. 15A, the first chip 910 may also include at least portions of the readout circuit 140, the threshold generation circuit 130 and/or the controller 120 or the entire control unit.

The second chip 920 may be mainly a logic chip (digital chip) that includes the elements complementing the circuits on the first chip 910 to the solid-state imaging device 23020. The second chip 920 may also include analog circuits, for example circuits that quantize analog signals transferred from the first chip 910 through the TCVs.

The second chip 920 may have one or more bonding pads BPD and the first chip 910 may have openings OPN for use in wire-bonding to the second chip 920.

The solid-state imaging device 23020 with the laminated structure of the two chips 910, 920 may have the following characteristic configuration:

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

Typically, the first chip 910 includes a p-type substrate and formation of p-channel MOSFETs typically implies the formation of n-doped wells separating the p-type source and drain regions of the p-channel MOSFETs from each other and from further p-type regions. Avoiding the formation of p-channel MOSFETs may therefore simplify the manufacturing process of the first chip 910.

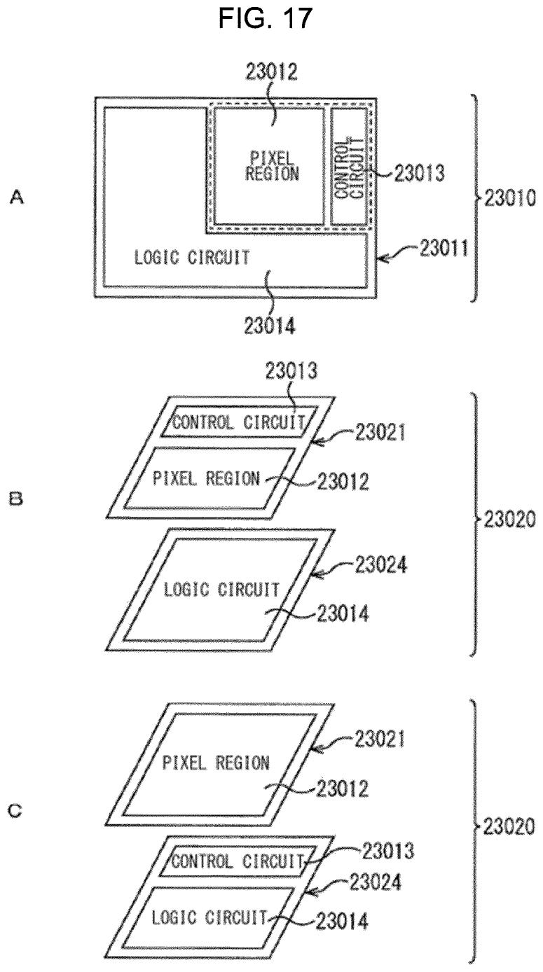

FIG. 17 illustrates schematic configuration examples of solid-state imaging devices 23010, 23020.

The single-layer solid-state imaging device 23010 illustrated in part A of FIG. 17 includes a single die (semiconductor substrate) 23011. Mounted and/or formed on the single die 23011 are a pixel region 23012 (photoelectric conversion elements), a control circuit 23013 (readout circuit, threshold generation circuit, controller, control unit), and a logic circuit 23014 (pixel back-end). In the pixel region 23012, pixels are disposed in an array form. The control circuit 23013 performs various kinds of control including control of driving the pixels. The logic circuit 23014 performs signal processing.

Parts B and C of FIG. 17 illustrate schematic configuration examples of multi-layer solid-state imaging devices 23020 with laminated structure. As illustrated in parts B and C of FIG. 17, two dies (chips), namely a sensor die 23021 (first chip) and a logic die 23024 (second chip), are stacked in a solid-state imaging device 23020. These dies are electrically connected to form a single semiconductor chip.

With reference to part B of FIG. 17, the pixel region 23012 and the control circuit 23013 are formed or mounted on the sensor die 23021, and the logic circuit 23014 is formed or mounted on the logic die 23024. The logic circuit 23014 may include at least parts of the pixel back-ends. The pixel region 23012 includes at least the photoelectric conversion elements.

With reference to part C of FIG. 17, the pixel region 23012 is formed or mounted on the sensor die 23021, whereas the control circuit 23013 and the logic circuit 23014 are formed or mounted on the logic die 23024.

According to another example (not illustrated), the pixel region 23012 and the logic circuit 23014, or the pixel region 23012 and parts of the logic circuit 23014 may be formed or mounted on the sensor die 23021, and the control circuit 23013 is formed or mounted on the logic die 23024.

Within a solid-state imaging device with a plurality of photoreceptor modules PR, all photoreceptor modules PR may operate in the same mode. Alternatively, a first subset of the photoreceptor modules PR may operate in a mode with low SNR and high temporal resolution and a second, complementary subset of the photoreceptor module may operate in a mode with high SNR and low temporal resolution. The control signal may also not be a function of illumination conditions but, e.g., of user settings.

### Application Example to Mobile Body

The technology according to the present disclosure may be realized, e.g., as a device mounted in a mobile body of any type such as automobile, electric vehicle, hybrid electric vehicle, motorcycle, bicycle, personal mobility, airplane, drone, ship, or robot.

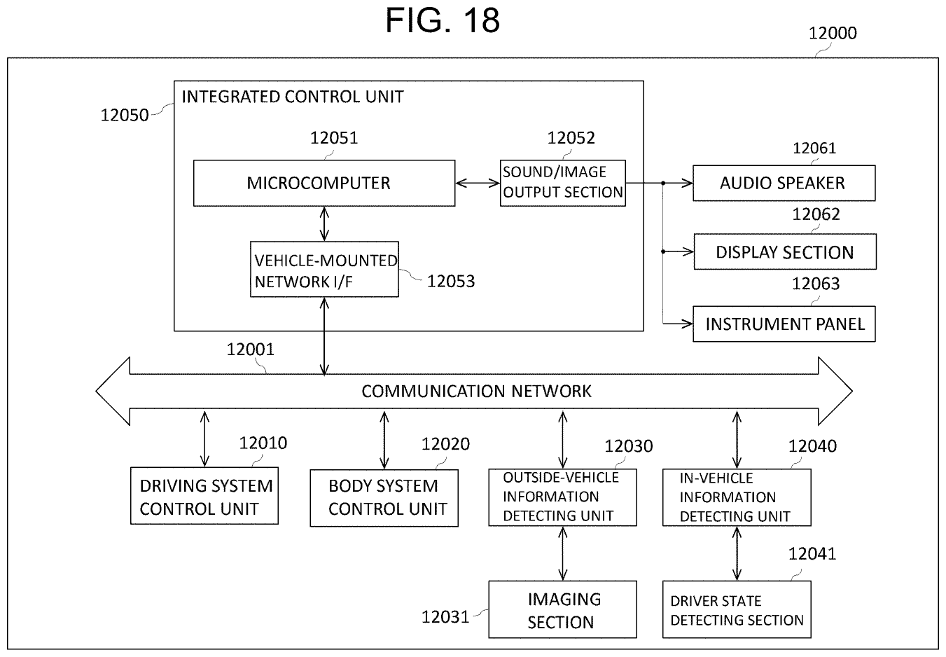

FIG. 18 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 18, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle. The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a solid-state imaging sensor with event detection and photoreceptor modules according to the present disclosure. The imaging section 12031 may output the electric signal as position information identifying pixels having detected an event. The light received by the imaging section 12031 may be visible light, or may be invisible light such as infrared rays or the like.

The in-vehicle information detecting unit 12040 detects information about the inside of the vehicle and may be or may include a solid-state imaging sensor with event detection and photoreceptor modules according to the present disclosure. The in-vehicle information detecting unit 12040 is, for example, connected with a driver state detecting section 12041 that detects the state of a driver. The driver state detecting section 12041, for example, includes a camera focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040 and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 18, an audio speaker 12061, a display section 12062, and an instrument panel 12063 are illustrated as the output device. The display section 12062 may, for example, include at least one of an on-board display or a head-up display.

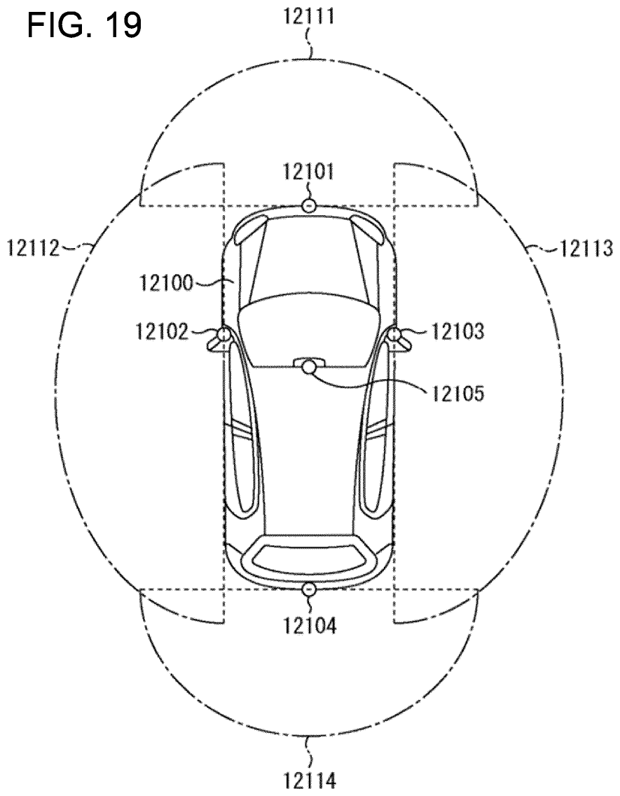

FIG. 19 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 19 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062 and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to the present disclosure is applicable has been described above. By applying the photoreceptor modules for obtaining event-triggered image information, the image data transmitted through the communication network may be reduced and it may be possible to reduce power consumption without adversely affecting driving support.

Additionally, embodiments of the present technology are not limited to the above-described embodiments, but various changes can be made within the scope of the present technology without departing from the gist of the present technology.

The solid-state imaging device according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g. a solid-state image device, provided for use in medical and healthcare, such as an endoscope or a device that performs angiography by receiving infrared light.

In the field of security, the solid-state imaging device can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

The present technology can also be configured as described below:

[1] A sensor device (1000) for generating depth information for an object (O), comprising:
a projector unit (1010) that is configured to project illumination patterns to the object (O);
a receiver unit (1020) that is configured to detect intensities of light reflected from the object (O) stemming from the illumination with the illumination patterns and/or from illumination with ambient light; and
a control unit (1030) comprising
   a system parameter unit (1035) that is configured to set system parameters (SP) of the sensor device (1000),
   a decoder unit (1036) that is configured to generate the depth information based on the illumination patterns reflected from the object (O) and detected by the receiver unit (1020), and
   an optimizer unit (1037) that is configured to determine system parameter (SP) changes that maximize the depth sensing performance in current environmental conditions.
[2] The sensor device (1000) according to [1], wherein the optimizer unit (1037) is configured to determine the system parameter (SP) changes by executing the following steps:
applying (S110) a modulation (MSP) to a system parameter (SP) to be optimized at a specific frequency,
detecting (S120) I-Q components of the depth information signal of the decoder unit (1036) that oscillates at the applied modulation frequency,
extracting (S130) the Q component and using it as an estimate of the signal derivative with respect to the system parameter (SP) to be optimized, and
applying (S140) a change in the system parameter in dependence to the value of the signal derivative.
[33 ] The sensor device (1000) according to [2], wherein the optimizer unit (1037) is further configured to repeat (S150) the steps (S110 to S140) according to [2], until the depth sensing performance metric no longer improves.
[4]. The sensor device (1000) according to [1], wherein the optimizer unit (1037) is configured to determine the system parameter (SP) changes by executing the following steps:
applying (S110′) amplitude modulation (MSP) to each system parameter (SP) to be optimized, at a frequency unique to each system parameter (SP),
detecting (S120′) the component of the depth information signal of the decoder unit (1036) that oscillates at each of the applied parameter modulation frequencies by using demodulation and low-pass filtering to obtain the I-Q components of the depth information signal,
extracting (S130′) the Q component and using it as an estimate of the signal derivative with respect to the specific system parameter (SP), and
applying (S140′) a change in the system parameter in dependence to the value of the signal derivative.
[5] The sensor device (1000) according to [4], wherein the optimizer unit (1037) is further configured to repeat (S150′) the steps (S110′ to S140′) according to [4], until the depth sensing performance metric no longer improves.
[6] The sensor device (1000) according to any one of [2] to [5], wherein the optimizer unit (1037) is configured to apply (S140, S140′) a change in the system parameter proportional to the negative value of the signal derivative.
[7] The sensor device (1000) according to any one of [2] to [6], wherein the system parameters (SP) include projector system parameters (SP_Trans) of the projector unit (1010) and/or receiver system parameters (SP_Rec) of the receiver unit (1020).
[8] The sensor device (1000) according to [7], wherein the projector system parameters (SP_Trans) are selected from a list comprising an illumination pattern (IP), a sequence of illumination patterns (SIP), a light pulse duration (LPD), and a light pulse intensity (LPI).
[9] The sensor device (1000) according to [7] or [8], wherein the receiver system parameters (SP_Rec) are selected from a list comprising an optical parameter (OP) of the optical system of the receiver unit (1020), an exposure time (ET), a detection time window (DetTw), and event thresholds (EvTh).
[10] The sensor device (1000) according to any one of [1] to [9], wherein the projector unit (1010) is configured to project in a temporally consecutive manner a plurality of different illumination patterns (SIP) in a projection solid angle (PS) to the object (O), where the projection solid angle (PS) consists of a predefined number of predetermined solid angles and each illumination pattern (IP) is generated by deciding for each of the predetermined solid angles whether or not to illuminate the respective predetermined solid angle by projecting light into it.
[11] The sensor device (1000) according to [10], wherein the receiver unit (1020) comprises a plurality of pixels (1025), the receiver unit (1020) being configured to detect on each pixel (1025) intensities of light reflected from the object (O) stemming from the illumination with the illumination patterns and/or from illumination with ambient light.
[12] The sensor device (1000) according to [11], wherein the receiver unit (1020) is configured to generate an event at one of the pixels (1025) if the intensity detected at the pixel (1025) changes by more than a predetermined threshold, and the control unit (1030) is configured to generate the depth information based on all events generated during a predetermined time period.
[13] The sensor device (1000) according to any one of [1] to [12], wherein the light projected by the projector unit (1010) is infrared light and the ambient light is visible light.
[14] A method for operating a sensor device (1000) according to any one of [1] to [13], comprising the steps of
applying (S110) a modulation (MSP) to a system parameter (SP) to be optimized at a specific frequency,
detecting (S120) I-Q components of the depth information signal of the decoder unit (1036) that oscillates at the applied modulation frequency,
extracting (S130) the Q component and using it as an estimate of the signal derivative with respect to the system parameter (SP) to be optimized, and
applying (S140) a change in the system parameter in dependence to the value of the signal derivative.
[15] A processor of a control unit (1030) being configured to execute the method according to [14].

1. A sensor device for generating depth information for an object, comprising:
a projector unit that is configured to project illumination patterns to the object;
a receiver unit that is configured to detect intensities of light reflected from the object stemming from the illumination with the illumination patterns and/or from illumination with ambient light; and
a control unit comprising
a system parameter unit that is configured to set system parameters of the sensor device,
a decoder unit that is configured to generate the depth information based on the illumination patterns reflected from the object and detected by the receiver unit, and
an optimizer unit that is configured to determine system parameter changes that maximize the depth sensing performance in current environmental conditions.

2. The sensor device according to claim 1, wherein the optimizer unit is configured to determine the system parameter changes by executing the following steps:
applying a modulation to a system parameter to be optimized at a specific frequency,
detecting I-Q components of the depth information signal of the decoder unit that oscillates at the applied modulation frequency,
extracting the Q component and using it as an estimate of the signal derivative with respect to the system parameter to be optimized, and
applying a change in the system parameter in dependence to the value of the signal derivative.

3. The sensor device according to claim 2, wherein the optimizer unit is further configured to repeat the steps according to claim 2, until the depth sensing performance metric no longer improves.

4. The sensor device according to claim 1, wherein the optimizer unit is configured to determine the system parameter changes by executing the following steps:
applying amplitude modulation to each system parameter to be optimized, at a frequency unique to each system parameter,
detecting the component of the depth information signal of the decoder unit that oscillates at each of the applied parameter modulation frequencies by using demodulation and low-pass filtering to obtain the I-Q components of the depth information signal,
extracting the Q component and using it as an estimate of the signal derivative with respect to the specific system parameter, and
applying a change in the system parameter in dependence to the value of the signal derivative.

5. The sensor device according to claim 4, wherein the optimizer unit is further configured to repeat the steps according to claim 4, until the depth sensing performance metric no longer improves.

6. The sensor device according to claim 2, wherein the optimizer unit is configured to apply a change in the system parameter proportional to the negative value of the signal derivative.

7. The sensor device according to claim 1, wherein the system parameters include projector system parameters of the projector unit and/or receiver system parameters of the receiver unit,

8. The sensor device according to claim 7, wherein the projector system parameters are selected from a list comprising an illumination pattern, a sequence of illumination patterns, a light pulse duration, and a light pulse intensity.

9. The sensor device according to claim 7, wherein the receiver system parameters are selected from a list comprising an optical parameter of the optical system of the receiver unit, an exposure time, a detection time window, and event thresholds.

10. The sensor device according to claim 1, wherein the projector unit is configured to project in a temporally consecutive manner a plurality of different illumination patterns in a projection solid angle to the object, where the projection solid angle consists of a predefined number of predetermined solid angles and each illumination pattern is generated by deciding for each of the predetermined solid angles whether or not to illuminate the respective predetermined solid angle by projecting light into it.

11. The sensor device according to claims 10, wherein the receiver unit comprises a plurality of pixels, the receiver unit being configured to detect on each pixel intensities of light reflected from the object stemming from the illumination with the illumination patterns and/or from illumination with ambient light.

12. The sensor device according to claim 11, wherein the receiver unit is configured to generate an event at one of the pixels if the intensity detected at the pixel changes by more than a predetermined threshold, and the control unit is configured to generate the depth information based on all events generated during a predetermined time period.

13. The sensor device according to claim 1, wherein the light projected by the projector unit is infrared light and the ambient light is visible light.

14. A method for operating a sensor device according to claim 1, comprising the steps of
applying a modulation to a system parameter to be optimized at a specific frequency,
detecting I-Q components of the depth information signal of the decoder unit that oscillates at the applied modulation frequency,
extracting the Q component and using it as an estimate of the signal derivative with respect to the system parameter to be optimized, and
applying a change in the system parameter in dependence to the value of the signal derivative.

15. A processor of a control unit being configured to execute the method according to claim 14.
